(19) United States
(12) Patent Application Publication
(10) Pub. No.: US 2026/0264391 A1
(43) Pub. Date: Sep. 10, 2026

(54) CORRECTION DEVICE, IMAGE FORMING APPARATUS, AND CORRECTION METHOD

(71) Applicant: KONICA MINOLTA, INC., Tokyo (JP)

(72) Inventor: Hideyuki TORIYAMA, Aichi (JP)

(73) Assignee: KONICA MINOLTA, INC., Tokyo (JP)

(21) Appl. No.: 19/434,229

(22) Filed: Dec. 29, 2025

(30) Foreign Application Priority Data
Mar. 5, 2025 (JP) 2025-034596

(51) Int. Cl. B41J 2/045

(52) U.S. Cl. CPC B41J 2/04508; B41J 2/0451; B41J 2/04558; B41J 2/0456; B41J 2/04593; B41J 2/04586

(57) ABSTRACT

A correction device includes a hardware processor that determines, based on a landing result of a droplet on the recording medium for the nozzle, whether or not each of the droplets of the two or more sizes for the nozzle is abnormal, in which the hardware processor executes correction processing when a droplet having a size of an abnormality target is ejected at an abnormal nozzle.

### CROSS REFERENCE TO RELATED APPLICATIONS

The entire disclosure of Japanese patent Application No.2025 -034596, filed on Mar. 5, 2025, is incorporated herein by reference in its entirety.

### BACKGROUND

### Technological Field

The present invention relates to a correction device, an image forming apparatus, and a correction method.

### Description of Related Art

Conventionally, an image forming apparatus using an inkjet method is known. Such an image forming apparatus forms an image by ejecting droplets onto a recording medium from each of a plurality of nozzles provided in an ejection section.

However, in a case where an abnormal nozzle causing an ejection failure exists among the plurality of nozzles, an image failure may occur. Therefore, for example, Japanese Unexamined Patent Publication No. 2011-212932 discloses a configuration in which ejection from an abnormal nozzle is stopped and a portion corresponding to the abnormal nozzle is corrected using a nozzle other than the abnormal nozzle.

### SUMMARY

Meanwhile, in the image forming apparatus, there is an apparatus (for example, a configuration of a multi-drop method) in which each of the nozzles of the ejection section can eject droplets of two or more sizes. In such an image forming apparatus, there may be a nozzle that is abnormal for droplets having a predetermined size but is normal for droplets having a size different from the predetermined size.

With the configuration described in Japanese Unexamined Patent Publication No. 2011-212932, even such a nozzle is uniformly determined as an abnormal nozzle, and therefore, ejection from the abnormal nozzle is stopped even when an image in which droplets having a normal size are ejected is formed. Therefore, since correction is also performed on a nozzle that does not need to be corrected, there is room for improvement as a configuration for performing correction on an abnormal nozzle.

Objectives of the present invention include providing a correction device, an image forming apparatus, and a correction method that can efficiently perform correction processing for an abnormal nozzle in a configuration capable of ejecting droplets of two or more sizes.

In order to achieve at least one of the above-described objectives, a correction device reflecting one aspect of the present invention is a correction device in an image forming apparatus including an ejector having a plurality of nozzles, each of which is capable of ejecting droplets of two or more sizes onto a recording medium, the correction device including:

a hardware processor that determines, based on a landing result of a droplet on the recording medium for the nozzle, whether or not each of the droplets of the two or more sizes for the nozzle is abnormal, in which

the hardware processor executes correction processing when a droplet having a size of an abnormality target is ejected at an abnormal nozzle for which a droplet of at least one the two or more sizes is determined to be abnormal.

In order to achieve at least one of the above-described objectives, an image forming apparatus reflecting one aspect of the present invention includes:

an ejector having a plurality of nozzles, each of which is capable of ejecting droplets of two or more sizes onto a recording medium; and

the correction device described above, in which

the hardware processor controls the ejector so as to form an image on the recording medium based on the correction processing.

In order to realize at least one of the above-described objectives, a correction method reflecting one aspect of the present invention is

a correction method for an image forming apparatus including an ejector having a plurality of nozzles, each of which is capable of ejecting droplets of two or more sizes onto a recording medium, the correction method including:

determining, based on a landing result of a droplet on the recording medium for the nozzle, whether or not each of the droplets of the two or more sizes for the nozzle is abnormal; and

executing correction processing when a droplet having a size of an abnormality target is ejected at an abnormal nozzle for which a droplet of at least one the two or more sizes is determined to be abnormal.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an example of a configuration of an image forming apparatus according to an embodiment of the present invention;

FIG. 2 is a diagram illustrating an ejection face of an inkjet head;

FIG. 3 is a block diagram illustrating the main functional configuration of the image forming apparatus;

FIG. 4 is a diagram illustrating an example of an adjustment pattern;

FIG. 5 is a diagram illustrating an example of a droplet to be an abnormality target in an adjustment pattern;

FIG. 6 is a diagram illustrating an example of a pixel of interest to be corrected and candidate pixels located around the pixel of interest;

FIG. 7 is a flowchart illustrating an operation example of correction control in the image forming apparatus;

FIG. 8 is a diagram illustrating an example of a pixel of interest to be corrected and candidate pixels located around the pixel of interest;

FIG. 9 is a diagram illustrating an example of a pixel of interest to be corrected and candidate pixels located around the pixel of interest; and

FIG. 10 is a diagram illustrating an example of a pixel of interest to be corrected and candidate pixels located around the pixel of interest.

### DETAILED DESCRIPTION OF EMBODIMENTS

Hereinafter, one or more embodiments of the present invention will be described with reference to the drawings. However, the scope of the invention is not limited to the disclosed embodiments.

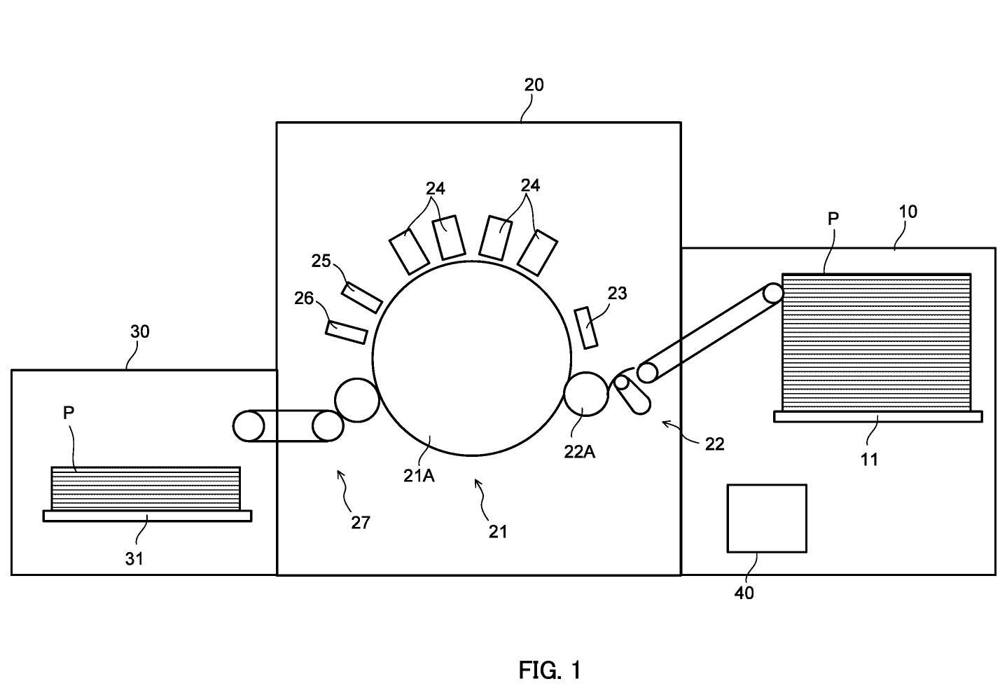

Hereinafter, an embodiment of the present invention will be described in detail with reference to the drawings. FIG. 1 is a diagram showing a schematic configuration of an image forming apparatus 1 according to an embodiment of the present invention.

The image forming apparatus 1 is an inkjet image forming apparatus (liquid ejecting apparatus) that records an image on a recording medium P. The image forming apparatus 1 further includes a sheet feed section 10, an image forming section 20, a sheet ejection section 30, and a controller 40.

The image forming apparatus 1 conveys the recording medium P stored in the sheet feed section 10 to the image forming section 20 under the control of the controller 40. The image forming apparatus 1 ejects ink onto the recording medium P to record an image thereon in the image forming section 20, and conveys the recording medium P having the image recorded thereon to the sheet ejection section 30.

The sheet feed section 10 includes a sheet feed tray 11 that stores the recording medium P, and the sheet feed section 10 conveys and supplies the recording medium P from the sheet feed tray 11 to the image forming section 20.

The image forming section 20 includes a conveyance section 21, a transport unit 22, a heating section 23, a head unit 24, an irradiation section 25, a reading section 26, and a delivery section 27.

The conveyance section 21 conveys the recording media P placed on a conveyance surface of a cylindrical conveyance drum 21A in a conveyance direction along the conveyance surface.

The transport unit 22 is provided at a position between the sheet feed section 10 and the conveyance section 21, and delivers one end of the recording media P conveyed from the sheet feed section 10 to the conveyance section 21 via the delivery drum 22A.

The heating section 23 is provided between the arrangement position of the transport drum 22A and the arrangement position of the head units 24, and heats the recording media P such that the recording media P have a temperature within a predetermined temperature range.

The head units 24 record an image by ejecting ink from the ink ejection face onto the recording media P at an appropriate timing corresponding to the rotation of the conveyance drum 21A on which the recording media P are held.

The head units 24 include a plurality of inkjet heads 100, and the inkjet heads 100 are arranged such that their ink (droplet) ejection faces are separated from the conveyance surface by a predetermined distance.

In the image forming apparatus 1 of the present embodiment, the four head units 24 respectively corresponding to the inks of the four colors of Y, M, C, and K are arranged at predetermined intervals in the order of the colors of Y, M, C, and K from the upstream side in the conveyance direction of the recording medium P.

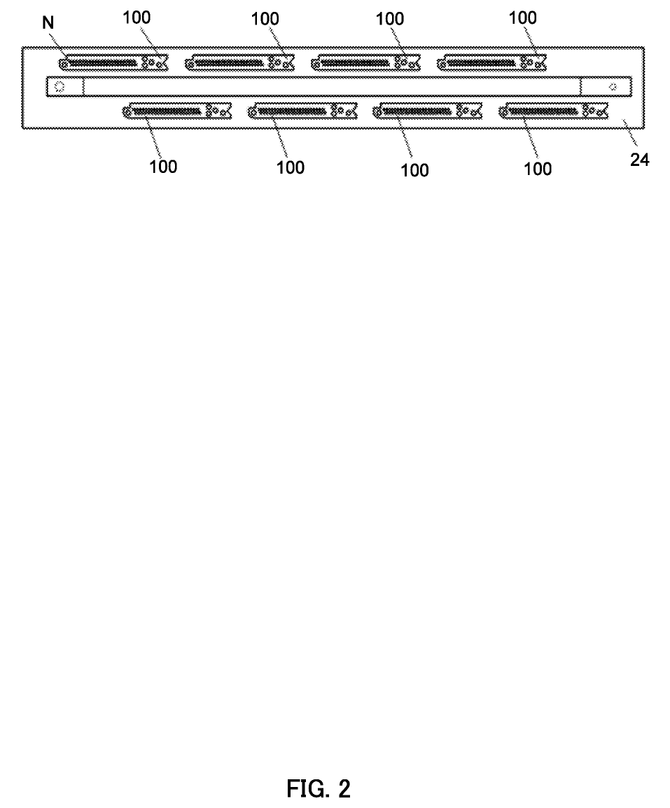

As illustrated in FIG. 2, the inkjet heads 100 are arranged next to each other in the width direction of the recording medium P on the ejection face side of each head unit 24. The ejection face of the inkjet head 100 is provided with a plurality of nozzles N equally spaced in the width direction. Since the plurality of nozzles N are provided in this manner, the image forming apparatus 1 can generate dots by ejecting droplets from the orifices of the nozzles N onto the recording medium P while moving the recording medium P in the conveyance direction. That is, the image forming apparatus 1 can form an image by a single pass.

As illustrated in FIG. 1, the irradiation section 25 is disposed over the width of the conveyance section 21, and irradiates the recording medium P placed on the conveyance section 21 with electromagnetic waves (e.g., ultraviolet rays) to cure and fix the ink ejected onto the recording medium P.

The reading section 26 reads information on the surface of the recording medium P on which the droplets ejected from the head units 24 and landed are fixed by the irradiation section 25. The reading section 26 includes a line sensor including, for example, a charge coupled device (CCD) sensor and a complementary metal oxide semiconductor (CMOS) sensor. The reading section 26 can detect the landing positions of the droplets on the recording medium P by one dimensionally imaging the recording medium P, which is conveyed by the operation of the conveyance section 21, in the width direction at appropriate timings.

The delivery section 27 conveys the recording medium P transported from the conveyance section 21 and sends it to the sheet ejection section 30.

The sheet ejection section 30 includes a sheet ejection tray 31 that has a plate shape and on which the recording medium P sent from the image forming section 20 by the delivery section 27 is placed.

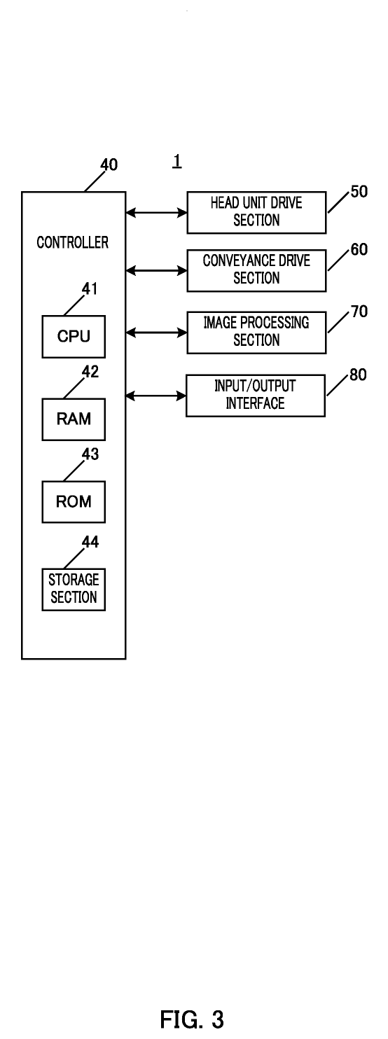

FIG. 3 is a block diagram illustrating a main functional configuration of the image forming apparatus 1. The image forming apparatus 1 includes a controller 40, a head unit drive section 50, a conveyance drive section 60, an image processing section 70, and an input/output interface 80.

The controller 40 includes a central processing unit (CPU 41), a random access memory (RAM 42), a read only memory (ROM 43), and a storage section 44, and comprehensively controls the entire operation of the image forming apparatus 1.

The CPU 41 reads various control programs and data items stored in the ROM 43, stores the read programs and data in the RAM 42, and executes the programs to carry out various calculation processes.

The RAM 42 provides a working memory space for the CPU 41 and stores temporary data. The RAM 42 may include a non-volatile memory.

The ROM 43 stores various control programs to be executed by the CPU 41, configuration data, and the like. Note that a rewritable nonvolatile memory such as an electrically erasable programmable read only memory (EEPROM) or a flash memory may be used instead of the ROM 43.

The storage section 44 stores a print job input from an external device (not illustrated) via the input/output interface 80, image data of an image to be recorded by the print job, and the like. As the storage section 44, for example, a hard disk drive (HDD) is used, and a dynamic random access memory (DRAM) or the like may be used in combination.

The head unit drive section 50 supplies a driving signal corresponding to image data to the recording element of the head unit 24 at an appropriate timing based on the control of the controller 40. Thus, an amount of ink corresponding to the pixel value of the image data is ejected from the nozzles of the head units 24.

The conveyance drive section 60 sends a driving signal to a conveyance drum motor provided at the conveyance drum 21A on the basis of the control signals from the controller 40 to rotate the conveyance drum 21A at predetermined rate and timing.

The image processing section 70 performs predetermined image processing on the image data stored in the storage section 44 and stores the obtained image data in the storage section 44. The image processing includes correction processing for correcting image data by applying a correction table or the like (not illustrated) to the image data, as well as color conversion processing, tone correction processing, and pseudo halftone processing.

The input/output interface 80 is connected to an input/output interface of an external device (for example, a personal computer), and mediates transmission and reception of data between the controller 40 and the external device.

In addition, in the present embodiment, each of the inkjet heads 100 has a configuration in which each nozzle N can eject droplets having two or more sizes to the recording medium P. Specifically, the inkjet head 100 includes, for example, a drive circuit corresponding to ejection of droplets by a multi-drop method in which droplets are continuously ejected a plurality of times for one dot. A known technology can be applied to the drive circuit.

Accordingly, the inkjet head 100 is configured to be able to eject, for example, one of a droplet having a small size and a droplet having a large size from each of the nozzles N to land the droplet on the recording medium P.

Incidentally, in the inkjet head 100, an ejection failure may occur such that the landing position of a droplet ejected from a nozzle N onto the recording medium P deviates from an ideal position. In a case where such ejection failure occurs, in the conventional technology, the nozzle having ejection failure is caused to stop ejection, and correction is performed using nozzles that are not having ejection failure and are located in the vicinity of the nozzle having ejection failure.

However, in the case of a configuration in which each nozzle can eject droplets of two or more sizes as in the present embodiment, there may be a nozzle that is abnormal for a droplet of a predetermined size but is normal for a droplet of a size different from the predetermined size.

In the conventional technique, such nozzles are uniformly set to stop ejection. Therefore, the droplet having a size different from the predetermined size is also not ejected, which results in inefficient correction processing.

In addition, since the peripheral nozzles of the abnormal nozzle in which the ejection is stopped are used in the correction as in the related art, in a high-frequency image such as a character image, there is a possibility that a slight image defect occurs due to the movement of the dots. In addition, a slight streak may occur in an image having a uniform density such as a halftone. Therefore, for example, even in the case of an abnormal nozzle in which only a droplet having a predetermined size is abnormal, it is considered that the occurrence of the above-described slight image defect can be suppressed by using the nozzle when a droplet having a size other than the predetermined size is ejected.

In the present embodiment, the controller 40 performs the correction processing when a droplet of an abnormality target size is ejected at an abnormal nozzle for which a droplet of at least one of the two or more sizes is determined to be abnormal.

By doing so, it is possible to efficiently perform the correction processing on the abnormal nozzle in the configuration in which droplets having two or more sizes can be ejected.

Specifically, the controller 40 determines whether or not each of the droplets of two or more sizes in each nozzle N is abnormal based on the landing result of the droplet on the recording medium P for each nozzle N. Then, the controller 40 executes the correction processing when a droplet of a size as an abnormality target is ejected from the abnormal nozzle determined to be abnormal. The controller 40 corresponds to a "determination section/determiner" and a "correction section/corrector" according to the present invention.

The landing result of the droplets on the recording medium P is a landing result by the adjustment pattern in which each of the nozzles N ejects droplets of two or more sizes.

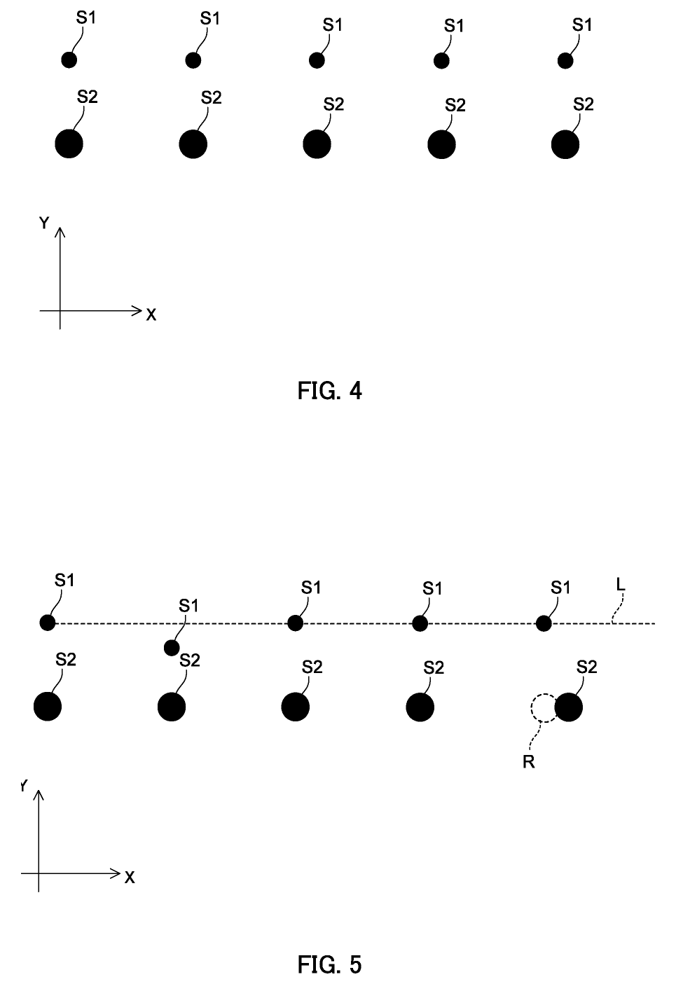

The adjustment pattern is, for example, a pattern in which droplets of a predetermined size are landed on the recording medium P from each of the two or more nozzles N so as to be arranged in a straight line. For example, as illustrated in FIG. 4, an example of a pattern is illustrated in which droplets S1 of the small size are arranged in a straight line and droplets S2 of the large size are arranged in a straight line in the width-direction (X-direction) of the recording medium P.

In the example illustrated in FIG. 4, the positions of the droplets S1 of the small size and the droplets S2 of the large size in the direction (Y direction) orthogonal to the widthwise direction are different from each other. The droplets at different positions in the X direction are droplets ejected from the nozzles N at different positions in the X direction. In addition, two droplets S1 and S2 at the same position in the X direction are droplets ejected by the same nozzle N.

Here, the controller 40 generates a linear approximation straight line (a straight line along the X direction) based on the data of the X coordinate and the Y coordinate of each of the droplets arranged in the X direction. The controller 40 determines that the droplet of the predetermined size in the predetermined nozzle is abnormal in a case where the deviation amount of the landing position of the droplet by the predetermined nozzle from the primary approximate straight line (ideal position) is equal to or greater than a first predetermined amount. The first predetermined amount is, for example, a value that cannot be allowed as the deviation amount of the landing position, and can be appropriately set.

In addition, the adjustment pattern is, for example, a pattern in which droplets of two or more sizes are landed on the recording medium P so as to be arranged in a straight line by a predetermined nozzle. For example, FIG. 4 shows an example of a pattern in which droplets S1 of a small size and droplets S2 of a large size from the same nozzle N are arranged in a straight line in the Y direction of the recording medium P.

Here, when the deviation amount of the landing position of each of the droplets S1 and S2 from the ideal position based on the X coordinates of the droplets S1 and S2 arranged in the Y direction is equal to or greater than the second predetermined amount, the controller 40 determines that the droplet of which the deviation amount is equal to or greater than the second predetermined amount among the two droplets S1 and S2 is abnormal. The ideal position is, for example, a position assumed from each nozzle, and may be, for example, a position in a correct image prepared in advance. The second predetermined amount is, for example, a value that cannot be allowed as the deviation amount of the landing position, and can be appropriately set.

Such determination of the landing position is performed based on the reading result of the reading section 26. That is, the controller 40 performs the determination based on the read information of the reading section 26.

For example, in the example illustrated in FIG. 5, among the droplets S1 of the small size, the second droplet S1 from the minus side in the X direction is greatly deviated from the primary approximate straight line L. In this case, it is determined that the droplet S1 of the small size from the nozzle N corresponding to the deviated droplet S1 is abnormal.

In addition, the droplet S2 on the most + side in the X direction is largely deviated from the ideal position R. In this case, the droplet S2 of the large size from the nozzle N corresponding to the deviated droplet S2 is determined to be abnormal.

Accordingly, in each nozzle N, it is possible to determine whether or not the droplet is abnormal for each size.

Note that abnormality may be determined similarly in a case where a droplet of each size in each nozzle N is not ejected, a case where a landed droplet does not become a desired size, or the like.

Next, the correction processing will be described.

The controller 40 performs the correction processing by correcting image data corresponding to an adjacent nozzle adjacent to the abnormal nozzle among the plurality of nozzles N in the inkjet head 100. The correction processing is, for example, a process of increasing the droplet amount of the adjacent nozzle more than the image data before the correction, so as to compensate for a portion of a droplet having a size to be an abnormality target in the abnormal nozzle. That is, the correction processing is a process of adding the image data of the abnormal nozzle to the image data of the adjacent nozzle.

Specifically, when performing the correction processing on the pixel of interest corresponding to the landing position of the droplet by the abnormal nozzle, the controller 40 performs the correction processing by correcting image data of a pixel selected from a plurality of candidate pixels located around the pixel of interest. The plurality of candidate pixels positioned around the pixel of interest are a plurality of pixels corresponding to the landing positions of the droplets by the adjacent nozzles.

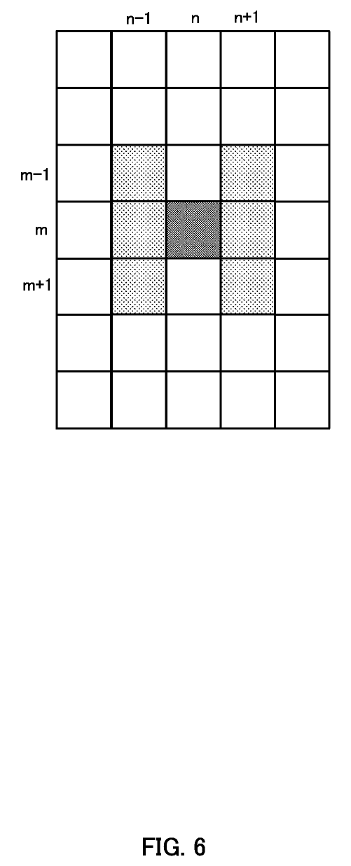

For example, as illustrated in FIG. 6, it is assumed that each pixel whose X coordinate on the recording medium P is n is a pixel corresponding to an abnormal nozzle, and each pixel whose X coordinate is n - 1 and each pixel whose X coordinate is n + 1 are pixels corresponding to adjacent nozzles.

Here, it is assumed that the pixel of interest is a pixel having an X coordinate of n and a Y coordinate of m (a pixel located at the center of FIG. 6). In this case, it is assumed that a plurality of candidate pixels located around the pixel of interest have X coordinates and Y coordinates of (n − 1, m − 1), (n − 1, m), (n − 1, m + 1), (n + 1, m − 1), (n + 1, m), and (n + 1, m + 1).

For example, the controller 40 selects one or more pixels from the plurality of candidate pixels and corrects the image data of the selected one or more pixels.

For example, in the abnormal nozzle, it is assumed that the droplet which is the abnormality target is a small-size droplet and the pixel of interest is a pixel on which the small-size droplet is landed. In this case, the controller 40 searches for, for example, a white pixel from among the plurality of candidate pixels. The white pixels are non-landed pixels on which no droplet is landed. In a case where a plurality of white pixels are included in the plurality of candidate pixels, a pixel selected randomly using a random number or the like or a pixel selected in a predetermined order is selected as the pixel to be used for the correction processing. Note that as a method of selecting a pixel to be used in the correction processing from among the candidate pixels, in addition to the above-described method, for example, a method of selecting a pixel that is the closest in distance from the pixel of interest can be exemplified.

The controller 40 changes the image data of the selected candidate pixel from white to a dot (droplet) having a small size.

For example, assume that in the image data before correction, the pixel at (n − 1, m) in FIG. 6 is a white pixel. In this case, the controller 40 converts, in the image data, the pixel at (n − 1, m) into a pixel corresponding to a small-size droplet, and the pixel at (n, m) into a white pixel.

Thus, the amount of droplets that are not ejected from the abnormal nozzle can be compensated for by the adjacent nozzle.

Further, in this case, the controller 40 may search for, for example, a pixel corresponding to a small-size droplet from among the plurality of candidate pixels. The method of searching for the pixel is the same as described above. The controller 40 changes the image data of the selected candidate pixel from a small-size droplet to a large-size droplet.

In addition, for example, in the abnormal nozzle, it is assumed that a droplet as an abnormality target is a large-size droplet. In this case, the controller 40 searches for, for example, a white pixel from among the plurality of candidate pixels.

The controller 40 changes the image data of the selected candidate pixel from white to a large-size droplet.

Further, in this case, the controller 40 may search for, for example, a pixel corresponding to a small-size droplet from among the plurality of candidate pixels. The method of searching for the pixel is the same as described above. The controller 40 may select two pixels corresponding to small-size droplets. The controller 40 changes the image data of the selected candidate pixel from the small-size droplet to the large-size droplet.

In this way, the controller 40 adjusts the number of candidate pixels to be selected according to the size of the droplet corresponding to the abnormal nozzle in the image data. Thus, the amount of droplets that are not ejected from the abnormal nozzle can be compensated for by the adjacent nozzle neither too much nor too little.

Note that the controller 40 may not select a pixel corresponding to a large-size droplet from among the plurality of candidate pixels. This is because, since the size cannot be increased any more, it is not possible to compensate for the amount of droplets that are no longer ejected from the abnormal nozzle.

As described above, the controller 40 changes the method of the correction processing according to the size of the droplet which is the abnormality target. Thus, the accuracy of the correction processing can be improved.

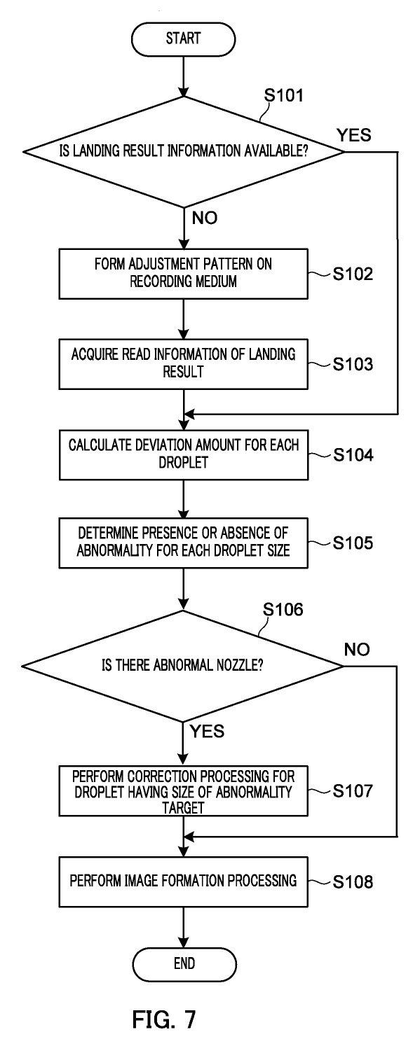

An operation example of the correction control of the image forming apparatus 1 configured as described above will be described. FIG. 7 is a flowchart illustrating an operation example of correction control in the image forming apparatus 1. Note that the present control is executed, for example, when setting input for a print job based on image formation on the recording medium P is provided.

As illustrated in FIG. 7, the controller 40 determines whether or not information on the landing result of the adjustment pattern is available (step S101). Specifically, the controller 40 determines whether or not information on the landing result of the adjustment pattern is stored in the storage unit or the like in advance.

As a result of the determination, when there is the information on the landing result (step S101, YES), the process proceeds to step S104. On the other hand, when there is no information of the landing result (step S101, NO), the controller 40 performs image formation of the adjustment pattern on the recording media P (step S102), and acquires read information of the landing result (step S103).

After Step S103, the controller 40 calculates the deviation amount of each droplet based on the landing result (Step S104), and determines the presence or absence of abnormality for each size of droplet for each abnormal nozzle (Step S105).

Next, the controller 40 determines, based on the information on the landing result, whether or not there is an abnormal nozzle (step S106). Specifically, the controller 40 determines that there is an abnormal nozzle in a case where there is a nozzle for which the deviation amount of each droplet is equal to or greater than a predetermined amount, and determines that there is no abnormal nozzle in a case where there is no nozzle for which the deviation amount of each droplet is less than the predetermined amount. As a result of the determination, in a case where there is no abnormal nozzle (step S106, NO), the process transitions to step S108.

On the other hand, when there is an abnormal nozzle (step S106, YES), the controller 40 executes correction processing for a droplet having a size of an abnormality target (step S107). Specifically, the controller 40 executes correction processing of changing the image data for each droplet having a size which is an abnormality target of each abnormal nozzle.

Next, the controller 40 executes image formation processing based on the image date (step S108). After step S108, the present control ends.

According to the present embodiment configured as described above, the controller 40 determines whether or not the droplets of two or more sizes in each nozzle are abnormal based on the landing result of the droplets on the recording medium P at each nozzle. Then, the controller 40 executes the correction processing when a droplet of a size as an abnormality target is ejected from the abnormal nozzle determined to be abnormal.

Thus, since the abnormality determination of the droplet is performed for each size, it is possible to perform the correction processing only on the droplet determined to be abnormal. As a result, it is possible to perform the correction processing on the droplet of the size which is the abnormality target while effectively utilizing the droplet of the normal size, compared to a configuration as in the related art in which the ejection is uniformly stopped with respect to the abnormal nozzle.

That is, in the present embodiment, it is possible to efficiently perform the correction processing on the abnormal nozzle in a configuration in which droplets of two or more sizes can be ejected.

Further, in the present embodiment, even if there is an abnormal nozzle, the ejection of droplets of a normal size is not stopped, and the droplets are used for image formation. Therefore, for an image that does not use droplets of the size that has been identified as the abnormality target, image formation can be performed in the same manner as for an image on which no correction processing is performed.

As a result, it is possible to reduce the occurrence of slight image failure caused by uniformly stopping ejection from the abnormal nozzles.

In addition, based on the landing result on the recording medium P, a deviation amount from an ideal position of the landing position of the droplet on the recording medium P for a predetermined nozzle is calculated for each size of the droplet, and based on the deviation amount, it is determined whether or not the droplet of each size is abnormal.

Accordingly, it is possible to accurately determine whether or not the droplet is abnormal for each size.

In addition, since the droplets having a predetermined size are landed from each of the two or more nozzles so as to be arranged on a straight line, it is possible to easily determine the deviation amount for each nozzle. As a result, it is possible to determine whether or not the droplet of the predetermined size at the predetermined nozzle is abnormal by a simple method.

Furthermore, since the controller 40 changes the method of the correction processing according to the size of the droplet that has been identified as the abnormality target, it is possible to improve the accuracy of the correction processing.

Note that although the correction processing is executed using the adjacent nozzle adjacent to the abnormal nozzle in the above-described embodiment, the present invention is not limited to this, and the correction processing may be executed using the droplet of the size determined not to be abnormal at the abnormal nozzle. The correction processing is, for example, a process of compensating for a portion of a droplet having a size which is an abnormality target at the abnormal nozzle by using a droplet having a size which is not an abnormality target at the abnormal nozzle.

For example, it is assumed that the two or more sizes at the abnormal nozzle include a first size corresponding to the droplet determined to be abnormal and a second size corresponding to the droplet determined not to be abnormal. In this case, the controller 40 performs the correction processing by applying the droplets of the second size to the image data corresponding to the droplets of the first size.

For example, it is assumed that a droplet having a small size is an abnormality target and a droplet having a large size is not an abnormality target in an abnormal nozzle. In this case, the controller 40 executes the correction processing so as to change the small-size droplet to the large-size droplet.

In addition, in a case where the small-size droplet is the abnormality target and the droplet of the large size is not the abnormality target in the abnormal nozzle, the controller 40 may execute the correction processing so as to change the small-size droplet to white.

In addition, in a case where the small-size droplet is the abnormality target and the droplet of the large size is not the abnormality target in the abnormal nozzle, the controller 40 may select the small-size droplet as any one of the droplet of the large size and white and may execute the correction processing. The selection method for selection as one of the large-size droplet and white may be, for example, a method of selecting one with a certain probability (e.g., 50%) or a method of selecting one at random. This is because there is a possibility that the density of the image cannot be maintained in a case where the change target is only one of the large-size droplet and white.

For example, it is assumed that in the abnormal nozzle, a large-size droplet is an abnormality target and a small-size droplet is not an abnormality target. In this case, the controller 40 executes the correction processing so as to change the large-size droplets to the small-size droplets.

In this case, image data of a plurality of candidate pixels around the pixel of interest may be corrected.

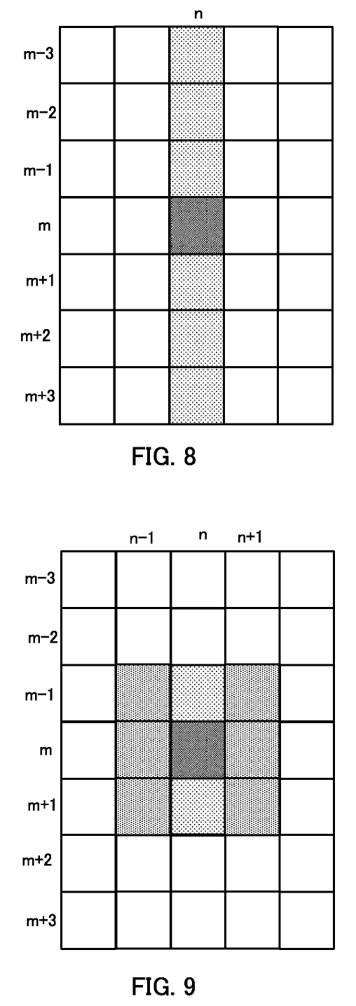

Here, as shown in FIG. 8, it is assumed that the pixel of interest is a pixel whose X coordinate is n and whose Y coordinate is m. In this case, it is assumed that a plurality of candidate pixels located around the pixel of interest have X coordinates and Y coordinates of (n, m − 1), (n, m − 2), (n, m − 3), (n, m + 1), (n, m + 2), and (n, m + 3). All of these candidate pixels are pixels corresponding to the abnormal nozzle.

For example, it is assumed that in the abnormal nozzle, a large-size droplet is an abnormality target and a small-size droplet is not an abnormality target. In this case, in the image data, as described above, the correction processing of changing the large-size droplets to the small-size droplets is performed, and in addition, the correction processing is also performed on the image data of the plurality of candidate pixels.

For example, the controller 40 selects one of the plurality of candidate pixels and corrects the image data of the selected one pixel. Specifically, the controller 40 searches for, for example, a white pixel (non-landed pixel) from among the plurality of candidate pixels. The controller 40 changes the image data for the selected candidate pixels from white to small-size droplets.

For example, in FIG. 8, when the pixel corresponding to (n, m + 1) is a white pixel, the controller 40 changes the image data of the pixel corresponding to (n, m + 1) to the data corresponding to the droplet of the second size.

By doing so, it is possible to compensate for the shortage of droplets in the pixel of interest by the surrounding pixels.

In addition, the correction processing may be executed by selecting any one of the first correction using the droplet of the size which is not abnormal in the abnormal nozzle and the second correction using the adjacent nozzle adjacent to the abnormal nozzle.

Here, as shown in FIG. 9, it is assumed that the pixel of interest is a pixel whose X coordinate is n and whose Y coordinate is m. In this case, it is assumed that a plurality of candidate pixels located around the pixel of interest have X coordinates and Y coordinates of (n, m − 1), (n, m + 1), (n − 1, m − 1), (n − 1, m), (n − 1, m + 1), (n + 1, m − 1), (n + 1, m), and (n + 1, m + 1). Of these candidate pixels, (n, m − 1) and (n, m + 1) are pixels corresponding to the abnormal nozzles. Among these candidate pixels, pixels (n − 1, m − 1), (n − 1, m), (n − 1, m + 1), (n + 1, m − 1), (n + 1, m), and (n + 1, m + 1) are pixels corresponding to adjacent nozzles.

For example, it is assumed that a droplet having a small size is an abnormality target and a droplet having a large size is not an abnormality target in an abnormal nozzle.

For example, in FIG. 9, the candidate pixel of (n, m + 1) adjacent to the pixel of interest is a pixel corresponding to the abnormal nozzle, but in a case where the candidate pixel is a pixel corresponding to a small-size droplet which is an abnormality target, the controller 40 selects the first correction and executes the correction processing. Specifically, the controller 40 changes the image data of one of the pixel of interest and the candidate pixel (n, m + 1) to a large-size droplet, and changes the image data of the other of the pixel of interest and the candidate pixel (n, m + 1) to a white pixel.

Thus, the pixel of interest and the candidate pixel can compensate for each other in terms of the amount of droplet.

In addition, in a case where the image data of the candidate pixel adjacent to the pixel of interest corresponding to the abnormal nozzle is not the small-size droplet, the controller 40 selects the second correction. The correction method of the second correction is the same as the correction processing in FIG. 6 and the like.

For example, it is assumed that in the abnormal nozzle, a large-size droplet is an abnormality target and a small-size droplet is not an abnormality target.

For example, in FIG. 9, the candidate pixel at (n, m − 1) adjacent to the pixel of interest is a pixel corresponding to the abnormal nozzle, but if the candidate pixel is a white pixel, the controller 40 selects the first correction and executes the correction processing. Specifically, the controller 40 changes the image data of both the pixel of interest and the candidate pixel of (n, m − 1) to a small-size droplet.

Thus, the pixel of interest and the candidate pixel can compensate for each other in terms of the amount of droplet.

In addition, when the image data of the candidate pixel adjacent to the pixel of interest corresponding to the abnormal nozzle is not a white pixel, the controller 40 selects the second correction. The correction method of the second correction is the same as the correction processing in FIG. 6 and the like.

By doing so, more appropriate correction processing can be selected, and therefore, occurrence of image degradation and the like due to the correction processing can be further suppressed.

In addition, when there are a plurality of abnormal nozzles among the plurality of nozzles N, two abnormal nozzles adjacent to each other may be included in the plurality of abnormal nozzles. In this case, since the adjacent nozzle adjacent to the pixel of interest is the abnormal nozzle, for example, when the second correction is selected, a case where the image data cannot be changed may occur.

Therefore, in this case, the controller 40 may widen the candidate pixel range at the pixel of interest corresponding to a droplet of one of the two abnormal nozzles adjacent to each other, compared to the case where the two abnormal nozzles adjacent to each other do not exist. The candidate pixel range is a range of a plurality of pixels located around the pixel of interest, and is a range determined as a range to be employed in the correction processing of the pixel of interest.

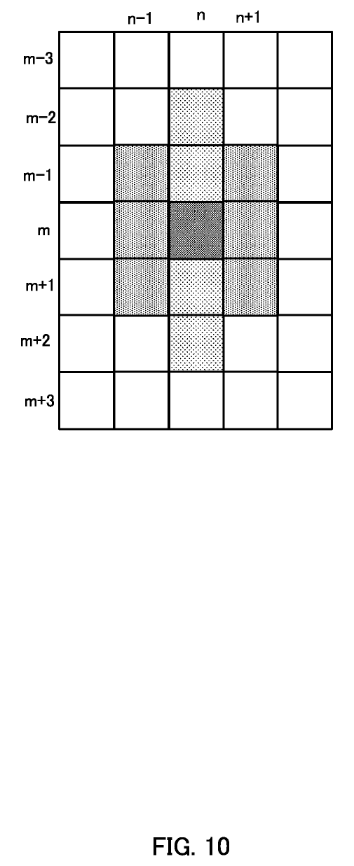

For example, as shown in FIG. 10, the controller 40 widens the candidate pixel range as compared with the example shown in FIG. 9. In FIG. 10, in addition to the candidate pixel range of FIG. 9, for example, (n, m − 2) and (n, m + 2) are added to the candidate pixels.

In this way, since it is possible to increase the range of compensating for the shortage of droplets in the pixel of interest due to the abnormal nozzle, it is possible to reduce the frequency of the occurrence of the case where the image data cannot be changed.

Furthermore, although the adjustment pattern is the pattern as illustrated in FIG. 4 in the above-described embodiment, the present invention is not limited thereto and may be any other pattern.

In addition, in the above-described embodiment, the configuration is such that droplets of two sizes, a small size and a large size, can be ejected, but the present invention is not limited thereto, and a configuration may be such that droplets of three or more sizes can be ejected.

In addition, in the above-described embodiment, the controller 40 constitutes the determination section and the correction section, but the present invention is not limited thereto, and the determination section and the correction section may be separately provided.

In the above-described embodiment, the correction device is the controller 40 of the image forming apparatus 1. However, the present disclosure is not limited thereto, and the correction device may be an external device of the image forming apparatus 1, such as a personal computer (PC) or a mobile terminal.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A correction device in an image forming apparatus including an ejector having a plurality of nozzles, each of which is capable of ejecting droplets of two or more sizes onto a recording medium, the correction device comprising:
a hardware processor that determines, based on a landing result of a droplet on the recording medium for the nozzle, whether or not each of the droplets of the two or more sizes for the nozzle is abnormal, wherein
the hardware processor executes correction processing when a droplet having a size of an abnormality target is ejected at an abnormal nozzle for which a droplet of at least one the two or more sizes is determined to be abnormal.

2. The correction device according to claim 1, wherein
the hardware processor calculates, for each size of the droplet, a deviation amount from an ideal position of a landing position of a droplet on the recording medium for a predetermined nozzle, and determines whether or not the droplet of each size at the predetermined nozzle is abnormal, based on the deviation amount calculated for each size.

3. The correction device according to claim 2, wherein:
the landing result is a result obtained by causing a droplet of a predetermined size to land on the recording medium from each of two or more nozzles including at least the predetermined nozzle such that the droplet is arranged in a straight line, and
in a case where the deviation amount of the landing position of the droplet by the predetermined nozzle from the straight line is equal to or more than a predetermined amount, the hardware processor determines that the droplet of the predetermined size at the predetermined nozzle is abnormal.

4. The correction device according to claim 1, wherein
the hardware processor changes a method of the correction processing in accordance with a size of a droplet which is an abnormality target.

5. The correction device according to claim 1, wherein
the hardware processor performs the correction processing by correcting image data corresponding to an adjacent nozzle adjacent to the abnormal nozzle among the plurality of nozzles in the ejector.

6. The correction device according to claim 5, wherein
when performing the correction processing on a pixel of interest corresponding to a landing position of a droplet by the abnormal nozzle, the hardware processor performs the correction processing by correcting image data of a pixel selected from among a plurality of candidate pixels located around the pixel of interest, the plurality of candidate pixels corresponding to a landing position of a droplet by the adjacent nozzle.

7. The correction device according to claim 1, wherein
when the two or more sizes at the abnormal nozzle include a first size corresponding to a droplet determined to be abnormal and a second size corresponding to a droplet determined not to be abnormal, the hardware processor performs the correction processing by applying the droplet of the second size to image data corresponding to the droplet of the first size.

8. The correction device according to claim 1, wherein
when the two or more sizes at the abnormal nozzle include a first size corresponding to a droplet determined to be abnormal and a second size corresponding to a droplet determined not to be abnormal, the hardware processor performs the correction processing by changing, with respect to image data corresponding to the droplet of the first size, the droplet of the first size to a non-landed pixel for which no droplet is to be landed.

9. The correction device according to claim 7, wherein
when a candidate pixel located around a pixel of interest to which the droplet of the second size has been applied and corresponding to the landing position for the abnormal nozzle is a non-landed pixel for which no droplet is to be landed, the hardware processor performs the correction processing so as to apply the droplet of the second size to a position corresponding to the non-landed pixel.

10. The correction device according to claim 7, wherein
the hardware processor is configured to perform the correction processing by selecting one of a first correction in which the droplet of the second size is applied and a second correction in which image data corresponding to an adjacent nozzle adjacent to the abnormal nozzle among the plurality of nozzles is corrected in the ejector.

11. The correction device according to claim 1, wherein:
the hardware processor is configured to:
in a case where the correction processing is performed on a pixel of interest corresponding to a landing position of a droplet by the abnormal nozzle, determine a range of a plurality of pixels located around the pixel of interest as a candidate pixel range employed in the correction processing for the pixel of interest, and
in a case where there are a plurality of abnormal nozzles and two abnormal nozzles adjacent to each other are included in the plurality of abnormal nozzles, set the candidate pixel range at the pixel of interest corresponding to a droplet of one of the two abnormal nozzles to be wider than in a case where the two abnormal nozzles adjacent to each other do not exist.

12. An image forming apparatus, comprising:
an ejector having a plurality of nozzles, each of which is capable of ejecting droplets of two or more sizes onto a recording medium; and
the correction device according to claim 1, wherein
the hardware processor controls the ejector so as to form an image on the recording medium based on the correction processing.

13. The image forming apparatus according to claim 12, wherein
the hardware processor is configured to:
control the ejector so as to form, on the recording medium, a pattern in which each of the plurality of nozzles ejects the droplets of the two or more sizes, and
determine, based on a landing result of the pattern on the recording medium, whether or not a droplet of each of the two or more sizes is abnormal.

14. The image forming apparatus according to claim 13, further comprising:
a reader capable of reading the landing result, wherein
the hardware processor performs determination based on read information of the reader.

15. A correction method for an image forming apparatus including an ejector having a plurality of nozzles, each of which is capable of ejecting droplets of two or more sizes onto a recording medium, the correction method comprising:
determining, based on a landing result of a droplet on the recording medium for the nozzle, whether or not each of the droplets of the two or more sizes for the nozzle is abnormal; and
executing correction processing when a droplet having a size of an abnormality target is ejected at an abnormal nozzle for which a droplet of at least one the two or more sizes is determined to be abnormal.
